(19) United States
(12) Patent Application Publication
(10) Pub. No.: US 2015/0304809 A1
(43) Pub. Date: Oct. 22, 2015

(54) METHOD FOR OPTIMIZING THE LOCATING ACCURACY OF AN RFID TAG IN AN ULTRA-HIGH FREQUENCY RADIO RANGE IN A SYSTEM FOR LOCATING RFID TAGS COMPRISING A PLURALITY OF READING DEVICES

(71) Applicant: SKIDATA AG, Groedig/Salzburg (AT)

(72) Inventor: THOMAS SCHLECHTER, Seekirchen Am Wallersee (AT)

(21) Appl. No.: 14/662,359

(22) Filed: Mar. 19, 2015

(30) Foreign Application Priority Data
Apr. 16, 2014 (EP) 14164917.8

(51) Int. Cl. H04W 4/02; G06K 7/10

(52) U.S. Cl. CPC H04W 4/02; G06K 7/10366

(57) ABSTRACT

In a method for optimizing the locating accuracy of an RFID tag in an ultra-high frequency radio range in a system for locating RFID tags in a room comprising a plurality of reading devices, a first step of locating of the RFID tag is initially carried out using methods known from the prior art, whereby for this purpose the RFID tag is detected by at least one reading device. Thereafter cold spots, i.e., points with minimal amplitude, are generated or moved in a targeted fashion in the room using a predetermined variation of the phase position, the frequency and/or the transmission amplitude of the individual reading devices, whereby their location and volume as a function of the phase position, the frequency and the transmission amplitude of the individual reading devices is known by means of simulations and/or measurements. If an RFID tag is no longer detected by any reading device, the same is located in a cold spot, which is identified by means of the first, rough locating of the RFID tag using methods known from the prior art, which allows for accurate locating of the RFID tag.

### BACKGROUND OF THE INVENTION

The present invention relates to a method for optimizing the locating accuracy of an RFID tag in an ultra-high frequency radio range in a system for locating RFID tags comprising a plurality of reading devices.

The RFID technology, in particular in the ultra-high frequency range (UHF) is known to a persons skilled in the art and has been used for some time in various applications. This includes applications in the fields of logistics, people and vehicle identification and also applications in the field of indoor navigation. Here, locating systems for RFID tags (RFID transponders) in an ultra-high frequency radio range comprise one or more UHF reading devices as well as a plurality of active and/or passive UHF RFID tags. Depending on the design of the system, either the reading devices or the UHF RFID tags are mobile, while the respective counterpart, i.e., the UHF RFID tags or the reading devices, are designed to be stationary.

Basically, existing reading devices—RFID tag systems—can be divided into two classes. Systems exist, on the one hand for identifying a person or an object using a unique identification of the RFID tag, which is communicated to at least one reading device as soon as the RFID tag is within the reading range of such reading device. On the other, systems exist for locating an RFID tag using locating methods known from the prior art.

Methods used for locating an RFID tag are, for example, two way ranging (TWR), signal strength based approaches (RSSI-based), time difference of arrival (TDOA), time of arrival (TOA) or phase difference of arrival (PDOA) methods, which are well known to a person skilled in the art. Except for the TWR and RSSI methods, a plurality of stationary installed reading devices is required for locating an RFID tag.

For systems with one or more reading devices for locating a UHF RFID tag, complete coverage of the area of interest is not necessarily provided since UHF waves are shielded, reflected and diffracted by metallic surfaces and objects. The reflections can overlap, which can lead to amplification or in extreme cases to extinction, and often arrive multiple times at the receiver due to multipath propagation, thus significantly degrading the locating accuracy. Systems comprising a plurality of reading devices can result in superimposition of the UHF signals transmitted by the individual reading devices, thus negatively affecting the detection and locating accuracy.

In order to improve the detection and locating accuracy in such systems for locating a UHF RFID tag, it is known to measure the area of interest already prior to the installation of a system or to simulate the UHF field distribution of the reading devices in the room in advance. This allows for optimal positioning of the reading devices in the room in order to ensure maximum performance, i.e., optimal coverage and an optimal interference pattern.

However, only a static problem in dependence on the environment is solved by this procedure. Disadvantageously, dynamic changes that occur, for example, when a person enters a room are not detected with this method.

To solve this problem, it has been proposed to provide stationary-installed reference RFID tags for systems comprising a plurality of reading devices, wherein the response behavior of these tags is examined during operation in order to obtain information about the field distribution in the room. These dynamic measurement results enable an optimization of the current reading device configuration which, in turn, leads to an optimized system performance.

Since the reference RFID tags are stationary, and thus are a fixed part of the overall system, it can be assumed that their response behavior can be predicted accurately for a defined UHF field. Static uncertainties, for example for unknown tags at objects or persons that are to be identified, can be minimized advantageously by reading and measuring the tags prior to installation. Since these reference tags respond in a known manner to excitation in the UHF field, the response behavior suggests the current field distribution in the room.

In this context, reference measurements and the corresponding field distribution can be stored in look-up tables, wherein the field distribution having the highest correlation is selected on the basis of the responses of the reference tags. One advantage of this method is that comparatively few reference tags and thus few reference measurements are necessary.

As an alternative to this approach, it is also possible to examine any desired scenario dynamically. However, numerous reference tags distributed in the room and many reference measurements are required for sufficient accuracy, which disadvantageously results in a reduced effective reading rate of the objects or persons to be identified. Hybrid solutions offer themselves as a compromise in practical applications and can alternatingly access the two aforementioned methods.

For systems with one or more reading devices for identifying a UHF RFID tag it is additionally known to randomly vary the basic parameters—phase, amplitude and frequency—of the individual reading devices. This creates hotspots, i.e., spots with maximum amplitude, and cold spots, i.e., spots with minimum amplitude, in the room due to the changing constructive and destructive superimposition of the UHF waves of the individual reading devices. If an RFID tag is located in a cold spot, not enough energy is available in the UHF field that would enable the RFID tag to respond to the request of one or more reading devices. By varying the named basic parameters, the hot and cold spots move in the room in dependence of the current configuration of the reading devices, which causes an RFID tag that is located in a cold spot to be subsequently located in an area with high field energy, thus allowing identification of the RFID tag.

### SUMMARY OF THE INVENTION

The principal objective of the present invention is to provide a method for optimizing the locating accuracy of an RFID tag in an ultra-high frequency radio range in a system for locating RFID tags comprising a plurality of reading devices.

This objective, as well as other objectives that will become apparent from the discussion that follows, are achieved, in accordance with the present invention, by providing a novel method for optimizing the locating accuracy of an RFID tag in an ultra-high frequency radio range (i.e., preferably in a range with a frequency of between 300 MHz and 3 GHz) in a system for locating RFID tags comprising a plurality of reading devices. In this context an initial locating step is carried out first using the methods known from the prior art, wherein for this purpose the RFID tag is detected by at least one reading device. Thereafter cold spots, i.e., points with minimal amplitude, are generated or moved in a targeted fashion in the room using a predetermined variation of the phase position, the frequency and/or the transmission amplitude of the individual reading devices, wherein their location and volume as a function of the phase position, the frequency and the transmission amplitude of the individual reading devices is known by means of simulations and/or measurements. If an RFID tag is no longer detected by any reading device, the same is located in a cold spot, which is identified by means of the initial, rough locating of the RFID tag using methods known from the prior art. This allows for accurate locating of the RFID tag.

The methods that can be used for the initial locating of the RFID tag can be, for example, two way ranging (TWR), signal strength based methods (RSSI-based), time difference of arrival (TDOA), time of arrival (TOA) or phase difference of arrival (PDOA) methods.

According to one embodiment of the invention, at least one reference RFID tag, at a stationary location, is used for the dynamic measurement of the field distribution. The response behavior of this at least one reference tag is examined during operation in order to obtain information about the field distribution in the room.

Using the concept according to the invention, the locating accuracy of an RFID tag, in an ultra-high frequency radio range in a system for locating RFID tags comprising a plurality of reading devices, is optimized without changing the system components. Existing systems can thus continue to be used, resulting in an increase in locating accuracy at low cost. The RFID tags can be designed as active tags (i.e., tags with a high energy supply) or as passive RFID tags.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a first plan view of a room with two stationary UHF emitting reading devices and two objects to be detected in a simplified simulation of the invention.

FIG. 2 is a second plan view of the room of FIG. 1 with the emitted UHF signals of the two reading devices shifted in phase.

FIG. 3 is a third plan view of the room of FIG. 1 with the emitted UHF signals of the two reading devices shifted further in phase.

### DESCRIPTION OF THE PREFERRED EMBODIMENTS

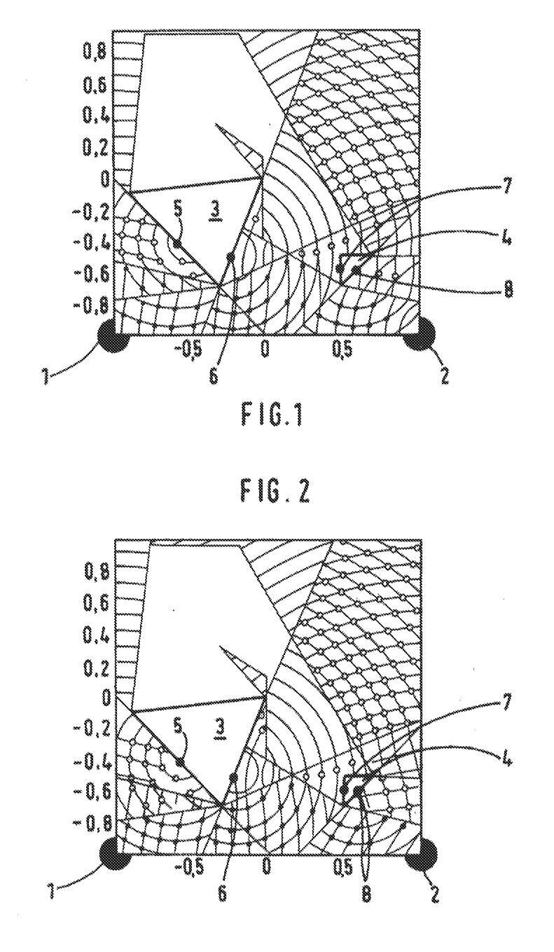

The preferred embodiments of the present invention will now be described with reference to FIGS. 1-3 of the drawings.

The accompanying FIGS. 1, 2 and 3 show a room with the corner points defined by their coordinates {(1,1) (1,−1) (−1,−1) (−1,1)}. Installed in the room are two reading devices in stationary locations, which are shown as black dots in the corner points 1 and 2 [at coordinates (−1, −1) and (1, −1) respectively]. Also located in the room are two objects 3 and 4, which are configured as triangles in exemplary fashion in the two-dimensional presentation of the figures. A lighter presentation of the field here indicates higher field strength.

The UHF field of the reading devices 1, 2 is shielded by the objects 3, 4, such that a UHF field can no longer be detected in the areas behind the objects. Also, the UHW waves sent from the reading devices 1, 2 are reflected by the objects 3, 4 at the impact surfaces, which are modeled by virtual radiation sources 5, 6, 7, 8, represented in the figures as small black dots in the white triangles 3, 4.

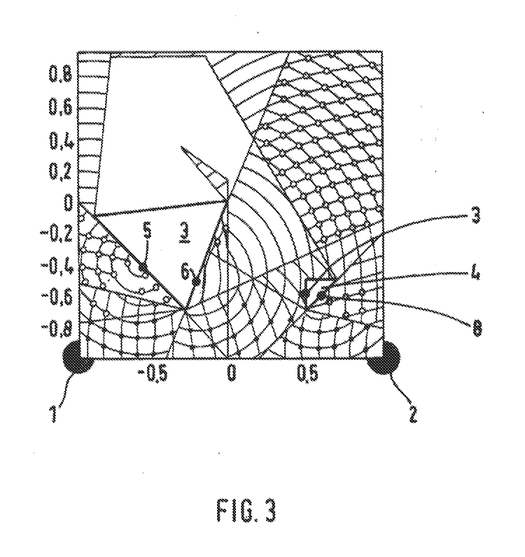

The feedback to requests by the radio field of the reading devices 1, 2 of responding UHF RFID tags can be modeled in the same manner. This very simplified simulation environment shows in FIG. 1 that a special distribution of hot and cold spots arises through the superimposition of the individual sources. There is no phase shift between the emitted UHF signals of the two reading devices in FIG. 1. In FIG. 2 the phase shift, between the emitted UHF signals of the two reading devices 1 and 2 is π/3 while in FIG. 3 it is 2π/3.

Referencing the accompanying figures one can recognize that the position of the hot spots (light dots) and cold spots (black dots) can be influenced solely by a rough variation of the phases of the emitted UHF signals of the reading devices. Using methods for the simulation of UHF environments, analysis of the necessary phase positions, the differences in frequency and differences in amplitude between the individual reading devices, all known from the prior art, a prediction of the position and the volume of hot spots and cold spots can be made in the respective room. Furthermore, at least one reference RFID tag in a stationary location can be used for the dynamic measurement of the field distribution.

According to the invention, it is proposed to generate or move cold spots in a targeted fashion by varying the phase position, the frequency and/or the transmission amplitude in order to determine more accurately the position of interesting RFID tags in the room after the initial locating step according to the prior art, thus making optimal locating possible. An RFID tag that does not react or respond to the UHF field of the reading device is located in a cold spot, which has been identified based on the prior, initial, rough locating of the RFID tag using methods known from the prior art. The cold spot in which the RFID tag is located is the cold spot that is closest to the determined coordinates based on prior, initial, rough locating of the RFID tag using methods known from the prior art.

Since the position and the volume of the cold spot as a function of the phase position, the frequency and the transmission amplitude of the individual reading devices are known based on simulations and/or measurements, the exact position of the RFID tag is known as well.

There has thus been shown and described a novel method for optimizing the locating accuracy of an RFID tag which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A method for optimizing the locating accuracy of an RFID tag in an ultra-high frequency radio range in a system for locating RFID tags in a room comprising a plurality of reading devices, wherein an initial step of locating of an RFID tag is carried out by detecting the RFID tag with at least one reading device, and thereafter points with a minimal amplitude (“cold spots”) are generated or moved in a targeted fashion in the room using a predetermined variation of at least one of phase position, frequency and transmission amplitude of the individual reading devices, wherein the location and volume of the RFID tags as a function of the phase position, the frequency and the transmission amplitude of the individual reading devices is known by means of at least one of simulations and measurements, and wherein, if an RFID tag is no longer detected by any reading device, such tag is located in a cold spot that is identified by means of the first, rough location of the RFID tag, thereby allowing for accurate locating of the RFID tag.

2. The method for optimizing the locating accuracy of an RFID tag in an ultra-high frequency radio range in a system for locating RFID tags in a room comprising a plurality of reading devices as defined in claim 1, wherein at least one stationary reference RFID tag is used for dynamic measurement of a field distribution in the room, and wherein a response behavior of the at least one reference tag is examined during operation in order to obtain information about the field distribution.

3. The method for optimizing the locating accuracy of an RFID tag in an ultra-high frequency radio range in a system for locating RFID tags in a room comprising a plurality of reading devices as defined in claim 1, wherein at least one of two-way ranging (TWR), signal strength based approaches (RSSI-based), time difference of arrival (TDOA), time of arrival (TOA) or phase difference of arrival (PDOA) methods are used for the initial locating of an RFID tag.
